(19) United States
(12) Patent Application Publication
(10) Pub. No.: US 2007/0078058 A1
(43) Pub. Date: Apr. 5, 2007

(54) Use of MCPP to inhibit tuber sprouting

(75) Inventors: Gary Stephen Olson, Salem, OR (US); Ronald K. Schafer, Boise, ID (US); Grace Gillard, Cheshire (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: ACETO AGRICULTURAL CHEMICALS CORP., Lake Success, NY (US)

(21) Appl. No.: 11/241,980

(22) Filed: Oct. 4, 2005

(51) Int. Cl. A01N 37/10

(52) U.S. Cl. 504/321

(57) ABSTRACT

The present invention relates to inhibiting the sprouting of potato tubers using MCPP.

FIELD OF THE INVENTION

The present invention relates to the use of MCPP to inhibit sprouting of tubers, particularly potato tubers, and most preferably the sprouting of tubers of stored potatoes. The application of MCPP to tubers also makes up a part of the invention, as do tubers having MCPP on at least a part of a surface thereof. Because potatoes are an important application of the present invention, they will be discussed in detail below. However, the invention is not limited thereto, and includes tubers in general such as other root crops like sweet potatoes and yams.

### BACKGROUND OF THE INVENTION

It is well known in the art to treat tubers such as potatoes with various chemicals having sprout-inhibiting properties. CIPC (chlorpropham, chlorprophame; chlor-IPC IUPAC name isopropyl 3-chlorocarbanilate; isopropyl 3-chlorophenylcarbamate; Chemical Abstracts name 1-methylethyl (3-chlorophenyl)carbamate EEC no. 202-925-7) has been conventionally used for this purpose for about 40 plus years. More recently, chemicals such as various isomers of diisopropylnaphalene and other substituted naphthalenes have exhibited for their sprout-inhibiting characteristics.

Potato tubers are often treated with a chemical sprout inhibitor in the storage season, and may receive another treatment of sprout inhibitor before being packaged for shipment to retail outlets. In the absence of chemical sprout inhibitors, the ultimate storage life is greatly reduced by loss of dormancy and early sprouting. Thus, virtually all potatoes stored mid and long term are treated with chemical sprout inhibitors.

Potatoes when being dug are frequently bruised, cut and/or abraded. These injuries to the potatoes oftentimes cause spoilage during shipment, storage and the like. A process known as suberization occurs naturally which tends to heal many of these injuries. However, whenever potatoes are stored, which occurs with a particularly large portion of potatoes harvested in any given year, if healing occurs slowly, a significant loss of potatoes can occur through spoilage. Early treatment with certain sprout inhibitors, such as CIPC, may retard the suberization process, thus contributing to the loss of potatoes through spoilage.

The main sprout inhibitors registered for use on potatoes are (CIPC), maleic hydrazide (MH), and dimethylnaphthalene (DMN) and Diisopropylnaphthalene (DIPN). The two chemicals in combination (CIPC plus DIPN) appear to be more effective at lower concentrations than either of the two chemicals alone. Simultaneous application of CIPC and DIPN provides improved results over application of either sprout inhibitors separately.

For example, it is relatively common in the potato storage industry to treat potatoes with Chloroisopropyl-N-carbamate (CIPC) to prevent or retard development of sprouts in the potatoes. Even though untreated potatoes are stored at a cool temperature, for example, generally between about 36-52° F., sprouting does begin to occur after a month or more of storage. Storage of upwards of six to ten months is typical for stored potatos. Thus, without treatment of a chemical such as CIPC, the stored potatoes become entangled in sprouts and the whole stored lot of potatoes may become economically useless. Although early treatment with CIPC could be advantageous for sprout inhibition purposes, application of CIPC is typically delayed until after suberization has occurred inasmuch as CIPC tends to retard suberization, resulting in accelerated rot and spoilage.

CIPC is typically applied in one or multiple applications to the tubers to be stored using thermal fogging techniques, sprays and powders. Conventional thermal fogging involving the application of CIPC into a stream of hot air or onto a hot surface of 550-1000° F., to produce a CIPC aerosol. The CIPC aerosol is circulated through potatoes piled in a potato storage building with the use of fans. Preferably the potatoes are turgid rather than soft when treated with the CIPC aerosol, since a pile of softened potatoes may be substantially compressed thereby impeding distribution of the aerosol. CIPC residue levels, will, however, typically decrease over time due to biodegration, venting and atmospheric loss. To extend the effective sprout inhibiting capability of CIPC, further applications may be needed.

CIPC is used in significant quantities world wide and is capable of suppressing sprouts on stored tubers with the chemical ability to limit cell division. Increased rates, multiple applications, addition of substituted naphthalene chemistries coupled with strict storage management strategies have been implemented to help reduce sprout development in CIPC treated potatoes. The instant invention provides an effective anti-sprouting treatment protocol that does not use CIPC and/or compliments the use of CIPC.

### SUMMARY OF THE INVENTION

The present invention embodies the inventors' discovery that MCPP inhibits the sprouting of tubers, particularly potato tubers, and that it can be used, if desired, in the same manner as conventional sprout inhibitors registered for use on potatoes. Of course, in addition to being used alone, MCPP can be used in concert with any other sprout inhibitor(s). While MCPP has been known as an herbicide for, e.g., cereals and grasslands, the inventors' discovery that MCPP inhibits the sprouting of tubers represents a new use for this material.

### DETAILED DESCRIPTION OF THE PREFERRED EMBODIMENTS

The active agent whose use in inhibiting the sprouting of tubers forms the basis of the present invention is known as “MCPP.” Other names include Mecoprop, mechlorprop, mecoprop, Mecoprop-P, Kilprop, Mecopar, Triester-II, Mecomin-D, Mecopex, Mecomec, and U46 KV Fluid (41, 43), the technical brochures, data sheets, and MSDS sheets thereof all incorporated herein by reference. Preferred MCPP compounds useful herein include (RS)-2-(4-chloro-o-tolyloxy)propionic acid (±)-2-(4-chloro-2-methylphenoxy)propanoic acid, CAS RN [7085-19-0] racemate; [93-65-2] (formerly used for mecoprop) unstated stereochemistry Development Codes RD 4593 (Boots); L143 (Marks), 2-(4-Chloro-o-tolyloxy) propionic acid otherwise known as 2-(4-Chloro-2-methylphenoxy)propanoic acid. Compounds with CAS#s 93-65-2 and 7085-19-0 are also preferred, as are (RS)-2-(4-chloro-o-tolyloxy)propionic acid, (R)-2-(4-Chloro-2-methylphenoxy)propionic acid and (S)-2-(4-Chloro-2-methylphenoxy)propionic acid. Also preferred are mecoprop-dimethylammonium [32351-70-5], mecoprop-diolamine [1432-14-0], mecoprop-ethadyl, mecoprop-isoctyl [28473-03-2], mecoprop-potassium [1929-86-8], mecoprop-sodium [19095-88-6], mecoprop-trolamine [53404-61-8]. A preferred MCPP compound for use in the present invention has the formula: 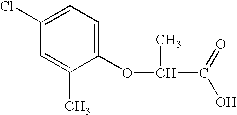
Included are racemic mixtures and all stereoisomers (molecules that are identical in atomic constitution and bonding, but differ in the three-dimensional arrangement of the atoms) thereof, including individual enantiomers and mixtures thereof. Similarly, all salts and esters of the above formula (including racemates and enantiomers thereof) and of all MCPP compounds are useful herein, especially the potassium, sodium and lithium salts thereof and the C₁-C₂₄ esters thereof. As is known by those of skill in this art, the salts and esters of the above formula replace the hydrogen (H) of the hydroxyl group (—OH) with, e.g., a metal ion (e.g., Na+, K+, etc.) or, e.g., an alkyl group (e.g., —CH₃), respectively. Preferred MCPP salts include the sodium and potassium salts. Preferred esters include C₁-C₂₄ branched or unbranched, substituted or unsubstituted alkyl and alkenyl esters, preferably C₁-C₁₀ unbranched, substituted or unsubstituted alkyl esters. “Substituted” refers to the replacement of hydrogen with a monovalent or divalent radical. Suitable substitution groups include, for example, hydroxyl, nitro, amino, imino, cyano, halo, thio, thioamido, amidino, imidino, oxo, oxamidino, methoxamidino, imidino, guanidino, sulfonamido, carboxyl, formyl, loweralkyl, haloloweralkyl, loweralkoxy, haloloweralkoxy, loweralkoxyalkyl, alkylcarbonyl, arylcarbonyl, aralkylcarbonyl, heteroarylcarbonyl, heteroaralkylcarbonyl, alkylthio, aminoalkyl, cyanoalkyl, and the like. As used herein, the terms “MCPP” and “MCPP compound” include all of these materials including all acids, salts and esters thereof, particularly C₁-C₂₄ esters thereof. In Europe MCPP is sometimes referred to as “CMPP.” As used herein “MCPP” and “MCPP compound” include CMPP.

As used herein, the term “tuber” is inclusive of “potato tuber.” “Potato tuber” refers to the underground storage organ of the potato plant (Solanum tuberosum). The potato tuber is a modified stem and includes buds that can sprout and form new potato plants. The term “(potato) tubers” refers to both tubers generally and to potato tubers. Preferred potatoes include Russet Burbank, Ranger Russet, Umatilla Russet, Shepody, Norkotah Russet, Yukon Gold, Norchip, Gem Russet, Atlantic, Chipeta, Snowden, and Dark Red Norland

The phrase “effective to inhibit sprouting” means that: (a) the number, and/or the weight, of stems (sprouts) growing from a defined number of (potato) tubers contacted with at least one MCPP compound in accordance with the present invention is less than the number, and/or the weight, of stems growing from the same number of control (potato) tubers (of the same cultivar as the treated (potato) tubers) that were not contacted with a sprouting inhibitor; and/or (b) the average rate of growth of stems growing from a defined number of (potato) tubers contacted with at least one MCPP compound in accordance with the present invention is less than the average rate of growth of stems growing from the same number of control (potato) tubers (of the same cultivar as the treated (potato) tubers) that were not contacted with a sprouting inhibitor. Such inhibition can be at any time as compared to the control. As understood by those in this field, the concept of inhibition is meaningful when control tubers show activity being inhibited in tubers contacted with at least one MCPP compound. Another preferred measure of inhibition is a comparison between the total amount of “dormant+sprout up to 3 mm” tubers at, e.g., 50 days after harvest as compared to untreated control. Whichever measure is used, preferred amounts of inhibition include less than 1%, 1%, 3%, greater than 3%, 5%, 8%, 10%, 20%, 30%, etc. to 100%.

The MCPP materials used herein can be purchased commercially, or synthesized by one of ordinary skill in the art. They can be used alone or in mixture, and can be applied together with other materials such as other sprout inhibitors. By “together,” we mean that the MCPP material(s) can be used in mixture with other materials such as active agents upon application to, e.g., potatoes, and/or can be used sequentially before, during, and/or after application of any other material. Useful combinations of MCPP with other materials include MCPA with one or more of CIPC, 2,4-D and dicamba. However, formulations including dicamba are not preferred due to the long residual of dicamba and the harmful effects that minute residues of dicamba cause in potato. Potatoes treated with dicamba or the surfaces contacted by these potatoes can render the storage and handling equipment trucks and such unfit for handing seed potatoes. The use of MCPP and CIPC together is a particularly preferred embodiment of the present invention. Other useful sprout inhibitors useful together with MCPP herein include DIPN (Diisopropyl naphthalene), methyl naphthalene and isomers of dimethyl naphthalene, especially 1,4 DMN. In addition, and regardless whether MCPP is utilized with any other active agent, the present invention includes multiple applications of MCPP on the same tuber, generally where the applications are spaced over certain time intervals.

In general, the present invention includes any application of MCPP to tubers, and particularly includes application to potato plants in the field before the potatoes are harvested, and/or application after the potatoes are harvested but before they are stored, and/or application after the potatoes are in storage. In a preferred embodiment the MCPP is applied via an aerosol, spray or thermal fog, or in microencapsulated form to harvested potatoes. Methods of application also include via aerosol can and via smoke generators, for example for treatment in rail cars. MCPP may also be first or subsequently applied after tubers (potatoes) have been harvested and stored for a sufficient period that bruises and cuts have healed, i.e., suberization has occurred. In another aspect of the invention, the MCPP is applied such that it inhibits sprouting during the potato shipping and distribution process.

In accordance with the foregoing, the present invention provides methods for inhibiting sprouting of potato tubers, the methods each including the step of contacting a potato tuber with an amount of at least one MCPP compound , wherein the amount of the at least one MCPP compound is effective to inhibit potato tuber sprouting. Typically, the at least one MCPP compound is applied simultaneously, or substantially simultaneously, to numerous, harvested, potato tubers. In the practice of the methods of the invention the at least one MCPP compound is applied after the potato tubers have been harvested, but typically not later than the onset of sprouting. In some embodiments of the methods of the invention, the effective amount of at least one MCPP compound is that amount sufficient to provide a dosage of from far less than 1 mg per/1 kg (parts per million) potato tubers to, e.g., 100 ppm, 500 ppm, and above. Preferred amounts include 0.01, 0.05, 0.1, 0.2, 0.3, 0.5, 1, 2, 3, 5, 8, 10, 15, 20, 25, 30, 35, 40, 50, 60, etc. ppm.

The instant invention includes a method of inhibiting the sprouting of stored tubers, especially potatoes, by applying a first sprout inhibiting chemical to the stored potatoes and then applying a second sprout inhibiting chemical at a later time, where at least one of the sprout inhibiting chemicals is at least one MCPP compound. Because multiple applications of MCPP makes up a part of the invention, the “second sprout inhibiting chemical” can be MCPP. Other useful sprout inhibitors include CIPC, and DMN (dimethyl naphthalene) or DIPN, especially 2,6 Disopropyl naphthalene. Multiple materials may be applied together, or the time elapsed between application of the first and second chemical applications may be from a few moments to several months. The second chemical is generally applied at a time span when the efficacy of the sprout inhibiting characteristics of the first chemical is waning. Application may be in any fashion, and may be according to the methods detailed in any of U.S. Pat. Nos. 4,226,179, 6,432882, 6,790,469, 6,855,669, 6,310,004, 6,107,247, 6,010,728, 6,001,773, 5,965,489, 5,436,226, 5,622,912 , 5,811,372, and 6,855,669 all incorporated herein by reference.

In accordance with the foregoing, in one aspect, the present invention provides methods for treating (potato) tubers, the methods each comprising the step of contacting a (potato) tuber with an amount of at least one MCPP compound. Preferably the amount of the at least one MCPP compound is an amount effective to inhibit (potato) tuber sprouting. However, this is not required. For example, when the at least one MCPP compound is used together with another sprout inhibitor, the at least one MCPP compound can be used in amount less than that effective to inhibit potato tuber sprouting. Preferably, of course, the total amount of sprout inhibitor (i.e., the amount of the at least one MCPP compound and any additional sprout inhibitor(s)) is effective to inhibit potato tuber sprouting. Such additional sprout inhibitors include, e.g. chlorpropham, maleic hydrazide, diisopropylnaphthalene, dimethylnaphthalene, carvone, aliphatic aldehydes and ketones, eugenol, benzothiazide, ethylene, aromatic acids (e.g., anisic acid, coumaric acid, gallic acid), rape oil methyl ester, medium and long-chain alcohols, jasmonates, aromatic aldehydes (e.g., benzaldehyde, salicaldehyde, cinnamaldehyde, hydrocinnamaldehyde, cuminaldehyde, thymol), monoterpenes (e.g., cineole, fenchone, menthol), and essential oils (e.g., mint oils)).

In the present invention, MCPP can also be used together with one or more antimicrobial and/or disease suppressing active agents, including products containing phosphites, hydrogen peroxide (dioxide), sodium chlorite, chlorine dioxide, thiobendazole, azoxystrobin, fludioxonil, and mancozeb.

In a preferred embodiment of the invention, the at least one MCPP compound is applied after the potato tubers have been harvested, but typically not later than the onset of sprouting. Thus, in some embodiments of the methods of the invention, the at least one MCPP compound is applied to the tubers within one, two, three, four five, six, seven or eight weeks after the tubers are harvested. Typically, the at least one MCPP compound is applied before the end of the natural dormancy period of the harvested potato tubers, i.e., before the buds on the potato tubers have begun to sprout. Preferably the at least one MCPP compound is applied as close to the end of the natural dormancy period as is practical. The duration of the natural dormancy period is known to those of skill in the art and varies between potato cultivars, and depends on such factors as the physiology and condition of the tubers at harvest, and the storage temperature. For example, depending on temperature and potato cultivar estimates (in days) of the natural dormancy period falls between about 70-140 days at temperatures of 45 -48° F.

If potatoes are subject to reconditioning, the at least one MCPP compound is typically applied at the beginning of the reconditioning period. Thus, in some embodiments of the invention, the at least one MCPP compound is applied one, two, three, four or five weeks before potato tubers are processed to make french fries or potato chips. In the practice of the methods of the invention, the at least one MCPP compound may be applied to the potato tubers on more than one occasion (e.g., at least twice) during the storage period.

Typically, but not as a requirement, the at least one MCPP compound is applied simultaneously, or substantially simultaneously, to numerous, harvested, potato tubers. Potatoes may be stored in bulk storage sheds designed to hold anywhere from, e.g., 5000 to 25000 tons. The sheds are designed to precisely control ventilation through the bulk pile (which may be about twenty five feet deep) along with temperature and relative humidity. Temperature is controlled by refrigeration and/or ventilation with outside air through cell decks which also raises the humidity. For example, the at least one MCPP compound can be volatilized at high temperature and applied as a thermal fog into the storage ventilation system that circulates air through the potato pile, from bottom to top. The storage sheds are generally closed tight after fogging, and the air may be circulated internally through the pile for several hours after application of the at least one MCPP compound. Again by way of example, the at least one MCPP compound can also be atomized or vaporized with various types of nozzles (e.g., air assisted, ultra-sonic or pressurized aerosol cans) or humidification apparatus to include centrifugal or cell decks and introduced onto the surface of one or more tubers via, e,g, the ventilation system of a storage sheds, or transit containers via humidification-type apparatuses such as humidifiers, drums, evaporators, filter pads, centripetal devices, and air assistance sprayers and via aerosol cans (smoke generators). Drenches, dips, dusts and sprays can also be used to apply the at least one MCPP compound. The at least one MCPP compound can also be impregnated on filters, or other inert materials, to facilitate slow release over time through the ventilation system of the storage sheds. The at least one MCPP compound can also be applied as an emulsifiable concentrate for spraying onto fresh market potatoes as they go through sorting and packing lines prior to bagging.

The amount of at least one MCPP compound that is applied to the potato tubers is preferably an amount effective to inhibit sprouting of the tubers. Sprouting inhibition can vary in the present invention from minimal, but some, inhibition to complete inhibition, including all variations there between.

In a preferred embodiment, stored potatoes are treated with an aerosol comprising at least one MCPP compound to provide an effective residue upon the potatoes to prevent or inhibit sprouting for a period of at least several weeks to several months depending upon the conditions of storage.

The amount of at least one MCPP compound that is effective to inhibit sprouting of the potato tubers depends on such factors as the composition comprising the at least one MCPP compound (e.g., neat, diluted, aerosol, etc.) and the potato cultivar being treated. In some embodiments of the methods of the invention, the at least one MCPP compound is applied to the potato tubers in an amount sufficient to provide a dosage of from any measurable amount such as 0.001 ppm to, e.g., 50, 100, 200, 500, 1000, etc. ppm.

The methods of the present invention are applicable to any potato cultivar including, but not limited to, Russet Burbank, Ranger Russet, Umatilla Russet, Shepody, Norkotah Russet, Yukon Gold, Norchip, Gem Russet, Atlantic, Chipeta, Snowden, and Dark Red Norland.

### EXAMPLES

The Research Potato Storage Facility Design

The storage system was designed to duplicate a large commercial storage facility in miniature. Drums containing 150-200 pounds of potatoes were sealed and housed in a building in which temperature was maintained throughout the testing period at 54 degrees F. for the first summer trial with Norkotah potatoes and 46 degrees F. for the Russet Burbank potatoes in the second trial. During both trials the humidity was maintained at and 96%. Formed in each drum is an inlet in which untreated air (ventilation air) was introduced under a perforated floor to the drum. The ventilation air moves through the pile of potatoes and is exhausted from the top of the drum to the outside of the building.

This storage ventilation was shut down for a 24 hour duration during and directly after the treatment of the chemicals. Then it is maintained for the duration of the trial, with ventilation air forced through the drums at a rate of 0.5 cubic feet per minute on a three-hour on and a three-hour off schedule.

Surface Sprays

In the spray application technique the formulations were mixed with water and sprayed on the newly harvested tubers at a rate of 5 and 10 parts per million (weight of the active to weight of the potatoes) mixed in a water carrier. The mixture was applied at 1 quart per ton of potatoes. The spray was applied via a hand held spray gun propelled with compressed air as the tubers were rotating in a cement mixer drum. This insured that all surface area is coated with the active ingredient.

The application system was thoroughly cleaned and decontaminated between each active ingredient.

All of the treatments in the reported test on Russet Norkotah used this technique with the exception of Untreated and CIPC A (CIPC 98A) that was thermal fogged.

Thermal Fogs

The Fogs were all applied with thermal foggers built to duplicate applications of commercial thermal fogging techniques.

The custom thermal fogger's heat source was an electric hot plate set at 500 degrees F. This temperature is monitored throughout the application with a thermal couple that is inserted in a cavity just below the surface where the chemical is placed. A chamber was attached to the hot plate. A fan was mounted to the top of the chamber. The fogger was attached to the storage container with flexible tubing.

The fog was delivered to each drum through separate ports. Through the bottom port of the storage drum a perforated stinger was installed that runs the length of the drum. Flexible tubing delivered the fog air mixture from the fogger. The fog air mixture was returned to the thermal fogger through a second flexible tubing that was attached from the top of the storage drum to the bottom of the thermal fogger. The air fog mixture was re-circulated through the system for five minutes.

The thermal foggers were cleaned and decontaminated when switching between actives and after each use.

Cultivar Selection

Russet Norkotah potatoes were selected for the first trial for their short natural dormancy and aggressive sprouting.

Russet Burbank potatoes were selected for the second trial. The Russet Burbank is noted for its long term storability and is one of the most popular cultivars used for storage as it can be used as both a fresh pack potato and also has very desirable processing qualities.

Evaluation

The potatoes were monitored for sprout activity on a regular basis after treatment. When early sprout activity was observed the potatoes were first evaluated. Then at approximately 30 day intervals, 60 tubers were randomly selected from each treatment. Each tuber was rated for the length of the longest sprout on each tuber. The scale used for the rating system as is follows:
0—Not Peeping=no sprout or swelling of eye tissue evident.
1—Peeping=swelling of eye tissue up to a sprout length of 3 mm
2—sprout length from 3 mm to 1 cm.
3—sprout length from 1 cm to 3 cm.
4—sprout length from 3 cm to 5 cm.
5—sprout length from 5 cm and longer

Results of each set of 60 tubers were recorded into 6 subsets of 10 tubers each (replicates). Each set is summarized as a percent. The data is also summarized into AVERAGE SPROUT LENGTH and PERCENT OK RE: FRESHPCK (Fresh pack).

The PERCENT OK RE: FRESHPCK is the percent of the tubers that are NOT PEEPING and PEEPING categories combined together.

The MCPP spray was a MCPP potassium salt providing 2.5 pounds active ingredient per gallon of inert ingredients (water/coformulants). The MCPP fog used MCPP technical grade acid 97.4% The 2,4-D[(2,4-(dichlorophenoxy)-acetic acid] acid was technical grade acid 2.5 pound per gallon. The 2,4-D LV was a commercial 2,4-D Low Volatile Ester, 3.8 pounds per gallon, LOW VOL 4 ESTER WEED KILLER (Isooctyl (2-ethylhexyl) ester of 2,4-Dichlorphenoxyacetic acid. All rates were calculated in parts per million of Active Ingredient by weight to pounds of potatoes treated.

Results

Russet Norkotah,
Analysis times are approximate days after harvest (DAH)
% OK for Fresh Pack
Dormant + sprout up to 3 mm

| Treatment | 53 DAH | 85 DAH | 107 DAH |
|---|---|---|---|
| 2,4 DB 5 ppm Spray | 81.7 | 3.3 | 0.0 |
| 2,4 DB 10 ppm Spray | 91.7 | 11.7 | 0.0 |
| MCPP 5 ppm Spray | 98.3 | 53.3 | 1.7 |
| MCPP 10 ppm Spray | 100.0 | 71.7 | 25.0 |
| Untreated Control | 81.7 | 8.3 | 0.0 |
| CIPC A 16.6 ppm Fog | 100.0 | 86.7 | 86.7 |

Russet Burbank
Thermal Fogs and Liquid Sprays
% OK For Fresh Pack
Dormant + sprout up to 3 mm
Approximate days after harvest

| Treatment | 132 | 161 | 191 | 223 | 252 | 283 |
|---|---|---|---|---|---|---|
| Untreated Control | 98.3 | 11.7 | 0.0 | 0.0 | 0.0 | 0.0 |
| MCPP 10 ppm Fog | 100.0 | 15.0 | 0.0 | 0.0 | 0.0 | 0.0 |
| MCPP 5 ppm Fog | 93.3 | 3.3 | 0.0 | 0.0 | 0.0 | 0.0 |
| MCPP 10 ppm Fog | 100.0 | 83.3 | 28.3 | 10.0 | 0.0 | 0.0 |
| CIPC 98A 11 ppm Fog | | | | | | |
| MCPP 5 ppm Fog | 100.0 | 90.0 | 15.0 | 0.0 | 0.0 | 0.0 |
| CIPC 98A 11 ppm Fog | | | | | | |
| CIPC 98A 11 ppm Fog | 100.0 | 26.7 | 0.0 | 0.0 | 0.0 | 0.0 |
| CIPC 98A 16.6 ppm Fog | 100.0 | 26.7 | 0.0 | 0.0 | 0.0 | 0.0 |
| DIPN 11 ppm Fog | 56.7 | 15 | 0 | 0 | 0 | 0 |
| MCPP 5 ppm Fog | 96.7 | 6.7 | 0 | 0 | 0 | 0 |
| DIPN 11 ppm Fog | | | | | | |
| 2,4 D Acid 5 ppm Fog | 100.0 | 16.7 | 0.0 | 0.0 | 0.0 | 0.0 |
| 2,4 D Acid 5 ppm Fog | 90.0 | 3.3 | 0.0 | 0.0 | 0.0 | 0.0 |
| CIPC 98A 11 ppm Fog | | | | | | |
| MCPP 5 ppm Spray | 100.0 | 95.0 | 73.3 | 38.3 | 6.7 | 5.0 |
| MCPP 10 ppm Spray | 100.0 | 100.0 | 90.0 | 65.0 | 20.0 | 10.0 |
| MCPP 5 ppm Spray | 100.0 | 100.0 | 100.0 | 90.0 | 75.0 | 73.3 |
| CIPC 98A 11 ppm Fog | | | | | | |
| MCPP 10 ppm Spray | 100.0 | 100.0 | 93.3 | 93.3 | 91.7 | 60.0 |
| CIPC 98A 11 ppm Fog | | | | | | |
| 2,4 D LV 5 ppm Spray | 96.7 | 30.0 | 8.3 | 0.0 | 0.0 | 0.0 |

Fog treatments are combined
Spray treatments are sequential

Concentration Analysis as it Relates to Sprout Inhibiting Results.

In addition to the above it was demonstrated that MCPP appears to break down rapidly when exposed to heat. Much better results were obtained with the spray applications compared to the thermal fog applications of MCPP, believed to be due to the fact that we established a higher concentration on the tuber via spray.

For example, for spray and thermal fog application, amounts recovered on the whole potato approximately four months later were as follows:
MCPP10 ppm applied via thermal fog=0.038 ppm
MCPP10 ppm applied via liquid spray=6.3 ppm

A highly preferred method for sprout control is liquid spray directly after harvest as potatoes are being loaded into the storage, although this application technique can have a negative impact on the natural wound healing (suberization) of cuts and wounds from harvest and handling. The delay of the natural wound healing process may allow additional time for storage diseases to establish in wounded areas which can lead to higher than normal storage losses to disease. A spray application going into storage for this product is not a preferred technique for agronomic reasons.

Other techniques preferred herein include:

a foliar spray on live vines prior to harvest;

liquid spray directly after harvest as potatoes are being loaded into the storage;

dry dust application after harvest as potatoes are being loaded into storage;

thermal fog to the potatoes in storage;

aerosol mist applied to potatoes in storage; and

liquid spray on potatoes prior to packing and shipping of the potatoes.

The above written description of the invention provides a manner and process of making and using it such that any person skilled in this art is enabled to make and use the same, this enablement being provided in particular for the subject matter of the appended claims, which make up a part of the original description and including:

a method for inhibiting sprouting of potato tubers, comprising contacting a potato tuber with at least one MCPP compound;

a potato tuber comprising, on at least a part of a surface thereof, at least one MCPP compound; and

an apparatus arranged to contact a potato tuber with a sprout inhibitor, said apparatus comprising therein at least one MCPP compound.

As used above, the phrases “selected from the group consisting of,” “chosen from,” and the like include mixtures of the specified materials.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out. Terms such as “contain(s)” and the like as used herein are open terms meaning ‘including at least’ unless otherwise specifically noted.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

What is claimed is:

1. A method for inhibiting sprouting of potato tubers, comprising contacting a potato tuber with an amount of at least one MCPP compound effective to inhibit sprouting.

2. The method of claim 1, wherein the amount of the at least one MCPP compound contacted to said potato tuber is an amount effective to inhibit sprouting in an amount greater than 3% at 50 days after harvest.

3. The method of claim 1, wherein the at least one MCPP compound comprises at least one MCPP compound of the following formula: 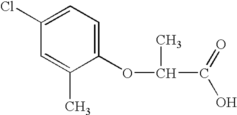
salts thereof, and the C₁-C₂₄ esters thereof.

4. The method of claim 2, wherein the at least one MCPP compound comprises at least one MCPP compound of the following formula: 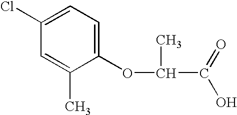
salts thereof, and the C₁-C₂₄ esters thereof.

5. The method of claim 1 wherein the at least one MCPP compound comprises (R)-2-(4-Chloro-2-methylphenoxy)propionic acid, the potassium salt thereof, or a mixture thereof.

6. The method of claim 1 wherein the at least one MCPP compound comprises (S)-2-(4-Chloro-2-methylphenoxy)propionic acid, the potassium salt thereof, or a mixture thereof.

7. The method of claim 2 wherein the at least one MCPP compound comprises (R)-2-(4-Chloro-2-methylphenoxy)propionic acid, the potassium salt thereof, or a mixture thereof.

8. The method of claim 2 wherein the at least one MCPP compound comprises (S)-2-(4-Chloro-2-methylphenoxy)propionic acid, the potassium salt thereof, or a mixture thereof.

9. The method of claim 1 wherein the amount of the at least one MCPP compound is sufficient to provide a dosage of less than 1 mg per/1 kg (parts per million) potato tubers.

10. The method of claim 1 wherein the potato tuber is from a cultivar selected from the group consisting of Russet Burbank, Ranger Russet, Umatilla Russet, Shepody, Norkotah Russet, Yukon Gold, Norchip, Gem Russet, Atlantic, Chipeta, Snowden, and Dark Red Norland.

11. The method of claim 1, wherein the potato tuber is contacted with the at least one MCPP compound during a time period extending from harvest of the tuber to one week prior to utilization by a processor or a consumer.

12. The method of claim 11, wherein the potato tuber is contacted with the at least one MCPP compound within one month after harvest.

13. The method of claim 11, wherein the potato tuber is contacted with the at least one MCPP compound within two months after harvest.

14. The method of claim 1, further comprising contacting said potato tuber with at least one non-MCPP compound sprout inhibitor.

15. The method of claim 14, wherein said at least one non-MCPP compound sprout inhibitor comprises CIPC.

16. The method of claim 1, wherein said at least one MCPP compound is in the form of a thermal fog.

17. The method of claim 1, wherein said at least one MCPP compound is in the form of an aerosol.

18. The method of claim 1, wherein said at least one MCPP compound is in the form of a liquid composition.

19. A potato tuber comprising, on at least a part of a surface thereof, at least one MCPP compound.

20. An apparatus arranged to contact a potato tuber with a sprout inhibitor, said apparatus comprising therein at least one MCPP compound.
